(19) United States
(12) Patent Application Publication
(10) Pub. No.: US 2020/0362622 A1
(43) Pub. Date: Nov. 19, 2020

(54) Flood Defense System

(71) Applicant: Nicholas Keith Christensen, Satellite Beach, FL (US)

(72) Inventor: Nicholas Keith Christensen, Satellite Beach, FL (US)

(21) Appl. No.: 16/413,471

(22) Filed: May 15, 2019

(51) Int. Cl. E06B 9/06; E02B 7/20

(52) U.S. Cl. CPC E06B 9/0692; E06B 2009/007; E02B 7/20

(57) ABSTRACT

A flood defense system for homes, structures and other buildings consisting of a watertight film (16) adhered by a sealant tape (10,12,14). The film (16) has high elongation properties to stretch and fill gaps, cracks, and other paths of liquids into buildings. The sealant tape (10,12,14) has high tack properties and is thick such that it can conform to textured surfaces which are often found on exterior walls. Together the sealant tape (10,12,14) and film (16) form a watertight seal which can be rapidly applied and later removed with no modification to existing building.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

### Field of Invention

The invention relates generally to flood protection, specifically an improvement in a flood protection kit, which inhibits flood water and/or any other liquids from entering a structure by applying a thin film membrane surrounding the entry and adhered to with a bead of sealant tape.

### Background of the Invention

Flooding events are predicted to increase due to global warming. The U.S. Global Change Research Program Climate Science Special Report, issued by 13 federal agencies, states that the “incidence of daily tidal flooding is accelerating in more than 25 Atlantic and Gulf Coast cities.”

Unwanted liquids entering structures cause damage to both structure and contents of the structure. Increase in events drive innovative solutions in order to protect structures and contents of structures.

The nature of flooding events drives unique requirements for preventative measures. Quick installation is often required as flooding events and severity are difficult to predict. A flood defense solution must be installed at a moments notice. Easy installation is often required as labor resources can be stretched thin. A homeowner may find him/herself alone to install flood protection.

Existing solutions do not meet unique requirements of increased intensity and frequency of flooding events. The sandbag is a well known solution, but requires large amount of material and labor resources to fill, transport, and place into position. Other solutions such as barriers require significant modification to existing structures, which are not quick to install.

This invention was conceived due to experiences in hurricane conditions. In some cases local governments give a limited number of sandbags per household for pre-hurricane preparations. Sandbags are extremely heavy to load and transport. Due to limited resources long lines form often resulting in a 2-3 hour wait.

This invention leverages existing technology from the composites industry. The materials used are bagging film and vacuum bag sealant tape. The vacuum bag and tape in traditional use form an airtight seal around a composite part on a tool or mold. In the case of composites, the bag forms a seal around the composites enabling a vacuum. In this invention flood water or other liquids apply the pressure on the bag. The invention can be applied quickly with little labor. The sealant tape is applied with hand pressure and can be removed by simply peeling it away.

### BACKGROUND OF INVENTION

### Objects and Advantages

Accordingly, besides the objects and advantages of the sealant system described in my above patent, several objects and advantages of the present invention are:

(a) to provide a flood defense system which can be rapidly installed;

(b) to provide a flood defense system which can be easily transported;

(c) to provide a flood defense system which is affordable;

(d) to provide a flood defense system which can be applied to a wide range of exterior doors, windows, and other paths for flooding;

(e) to provide a flood defense system designed to not require modifications to homes or buildings;

(f) to provide a flood defense system designed to be temporary;

(g) to provide a flood defense system designed to be lightweight;

(h) to provide a flood defense system designed to be rapidly removed after flooding event.

Further advantage is to provide a barrier, which can be used easily and conveniently to seal exterior doors, windows, and other entry points without modification to structure or home, which is simple to use and inexpensive to manufacture supplied in kits for various size entry points.

### SUMMARY

In accordance with the present invention, a flood defense system kit comprises a high elongation thin film and a tacky sealant tape.

### DRAWINGS—FIGURES

Drawings and descriptions of the invention are presented here. In the drawings, closely related figures have the same number, but different alphabetic suffixes.

FIG. 1A is an isometric illustration representing the invention applied to a typical exterior door.

FIG. 1B is a cross section through the invention as applied to a typical exterior door.

FIG. 2A is an isometric illustration representing the invention applied to a typical garage door.

FIG. 2B is a cross section through the invention as applied to a typical garage door.

FIG. 3A is an isometric illustration representing the invention applied to a typical exterior double door.

FIG. 3B is a cross section through the invention as applied to a typical double door.

FIG. 4 is an isometric illustration representing the invention applied to a typical exterior receptacle.

DRAWINGS -- Reference Numerals

| | | | |
|---|---|---|---|
| 10 | lower sealant tape | 12 | side sealant tape |
| 14 | upper sealant tape | 16 | film |

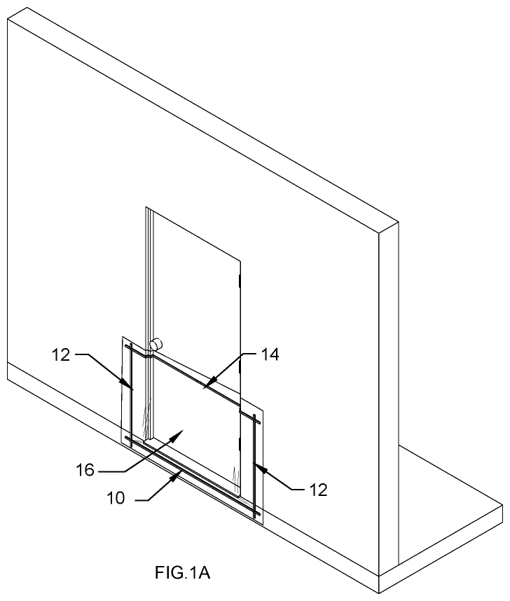

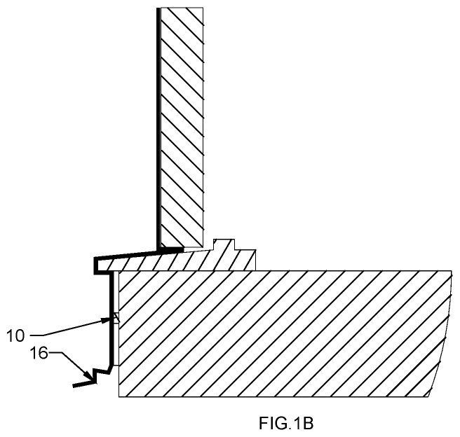

### DETAILED DESCRIPTION—FIGS. 1A AND 1B

A preferred embodiment of the flood defense system of the present invention is illustrated in FIG. 1A (isometric view) and FIG. 1B (cross section view) for application to a typical door. The flood defense system seals a typical door with a perimeter of sealant tape 10, 12, 14 and a thin high elongation film 16. In the preferred embodiment, the lower sealant tape 10, side sealant tape 12, and upper sealant tape 14, is a synthetic rubber strip ½ wide ⅛″ thick which is tacky on all sides available from Airtech International Incorporated of Huntington Beach, Calif. However, the sealant tape 10, 12, 14, can consist of any other material that has high tack and can be applied to rough surfaces found on exterior walls. In the preferred embodiment, the film 16 is a high elongation thermoplastic sheet available from Airtech International Incorporated of Huntington Beach, Calif. However, the film 16 can consist of any other material that has high elongation properties such as thermoplastic elastomers.

Because the invention is a kit for application, in the preferred embodiment a roll of sealant tape and film are included which is sized appropriately to treat the perimeter of an exterior door up from the foundation up to 24 inches or greater. The lower sealant tape 10, side sealant tape 12, and upper sealant tape 14, are provided in a roll.

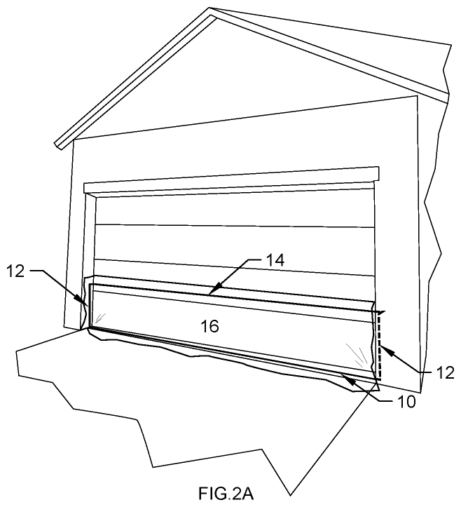

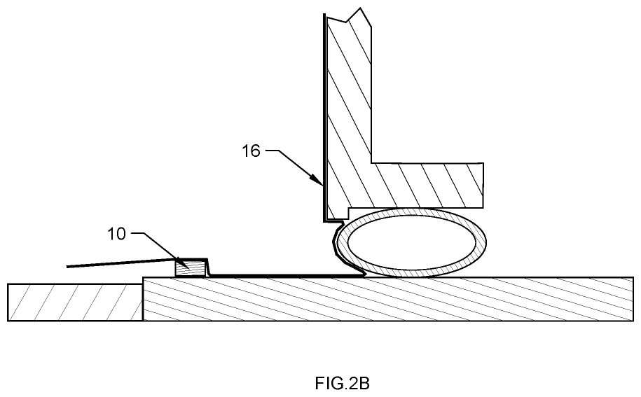

FIGS. 2A-2B—Additional Embodiment

An additional embodiment is shown in FIGS. 2A, 2B; in this case the flood defense system is applied to a typical garage door. For this embodiment, the flood defense system kit sealant tape 10, 12, 14 and film 16 would be sized appropriately for a typical garage door. Different kits would include single car garage door, two car garage door, and other typical dimensions.

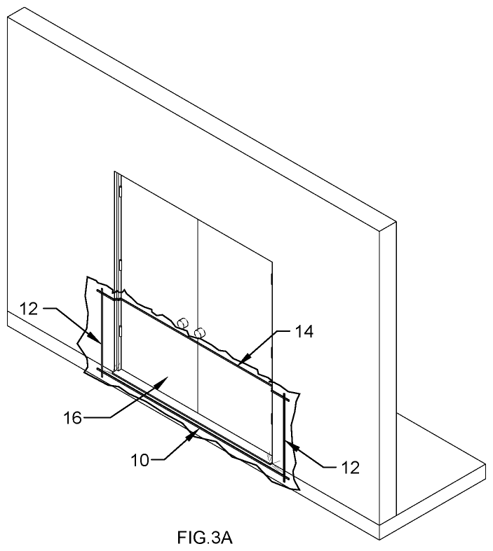

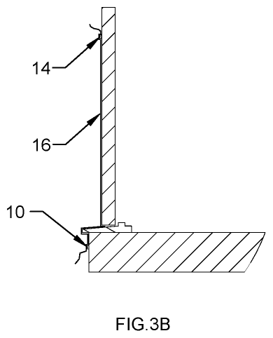

FIGS. 3A-3B—Additional Embodiment

An additional embodiment is shown in FIGS. 3A, 3B; in this case the flood defense system is applied to a typical double door. For this embodiment, the flood defense system kit sealant tape 10, 12, 14 and film 16 would be sized appropriately for a typical double door. Different kits would include sliding doors, and french doors.

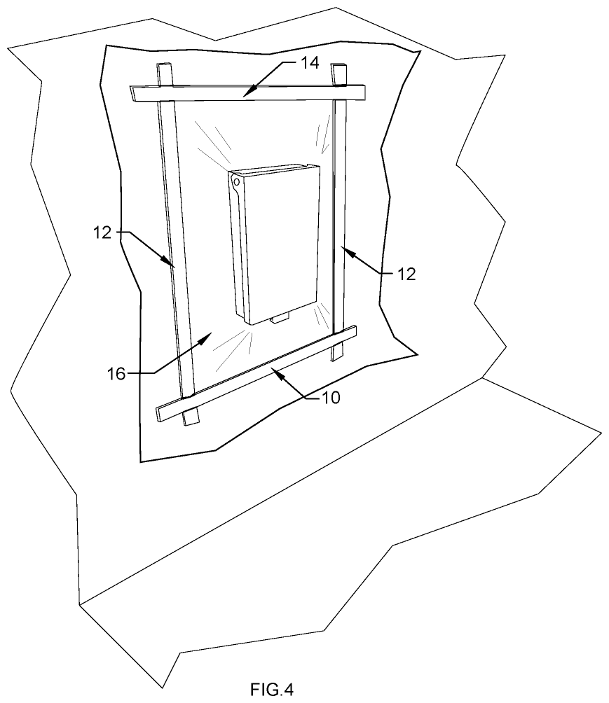

FIG. 4—Additional Embodiment

An additional embodiment is shown in FIG. 4; in this case the flood defense system is applied to a typical exterior receptacle. For this embodiment, the flood defense system kit sealant tape 10, 12, 14 and film 16 would be sized appropriately for a typical receptacle.

Operation—FIGS. 1A, 2A, 3A, 4

The manner of using the flood defense system to protect a home or structure is novel from existing methods. Namely, one first applies sealant tape forming a perimeter around the area to be sealed. The lower sealant tape 10 and side sealant tape 12 overlap. The side sealant tape 12 and upper sealant tape 14 overlap. Next, the film 16 is adhered to the sealant tape with firm hand pressure being careful not to form wrinkles between the film 16 and sealant tape 10, 12, 14. The film 16 should be applied loosely within the perimeter of the area to be sealed such that the film 16 can stretch to fill all cracks or other paths which liquids would fill.

Under flooding conditions water rises causing hydraulic pressure forcing the film 16 to stretch into the gaps. Initially the sealant tape 10, 12, 14 maintains a water tight seal, but as water rises hydraulic pressure is strong enough to hold the film 16 firmly against the home or structure and maintain a watertight seal.

To remove the flood defense system following a flooding event one simply peels the film 16 and sealant tape 10, 12, 14 from the home or structure.

### ADVANTAGES

From the description above, a number of advantages of my flood defense system become evident:

(a) Rolls of sealant tape and rolls of film will contain hundreds of square yards applicable to a variety of applications.

(b) With the use of rolls of sealant tape and film, the manufacturer can produce kits for various size application by simply providing different lengths of material.

### CONCLUSION, RAMIFICATIONS, AND SCOPE

Accordingly, the reader will see that the flood defense system can be used to seal paths of unwanted liquids easily and conveniently, can be removed just as easily and without damage to the structure or home, and requires no modifications to the structure or home. Furthermore, the flood defense system has the additional advantages in that it permits production of films and sealant tapes in a variety of shapes and sizes.

Although the description above contains many specificities, these should not be construed as limiting the scope of the invention, but merely providing illustrations of some of the presently preferred embodiments of this invention. For example, the film can have other shapes, such as circular, oval, trapezoidal, triangular, etc. for irregularly shaped areas; the upper sealant tape may not be necessary in cases of low wind; etc.

Thus the scope of the invention should be determined by the appended claims and their legal equivalents, rather than by the examples given.

I claim

1. A flood defense system kit to seal paths against passage of liquids comprising: a sealant tape and, a film.

2. A flood defense system kit according to claim 1 wherein the sealant tape comprises a synthetic rubber strip.

3. A flood defense system kit according to claim 1 wherein the film comprises a continuous sheet, comprising a thermoplastic elastomers.

4. A method of sealing paths against passage of liquids into buildings comprising the steps of:
cleaning building area to be clear of large particulates,
applying against the building the sealant tape forming a perimeter around the area which to seal,
disposing a thin film against the sealant.
